(19) United States
(12) Patent Application Publication
(10) Pub. No.: US 2009/0133374 A1
(43) Pub. Date: May 28, 2009

(54) Twisting Flyer

(76) Inventors: Heinz Fink, Krefeld (DE); Helmut Biller, Langenargen (DE)

Correspondence Address: K&L Gates LLP, 214 N. TRYON STREET, HEARST TOWER, 47TH FLOOR, CHARLOTTE, NC, 28202, US

(21) Appl. No.: 12/083,146

(22) PCT Filed: Sep. 30, 2006
(86) PCT No.: PCT/EP2006/009522

§ 371 Date: Apr. 3, 2008

(30) Foreign Application Priority Data
Oct. 15, 2005 (DE) 20 2005 016 198.5

(51) Int. Cl. D01H 13/10; H02K 49/04

(52) U.S. Cl. 57/112; 310/105

(57) ABSTRACT

Twisting flyer (1) comprising a rotary bush (6) and a hysteresis disc (7), arranged on a support sleeve (3), wherein the hysteresis disc (7) is arranged in the rotary bush (6) coaxially to the longitudinal axis of the support sleeve (3) and the rotary bush (6) has connecting elements (10) for the arrangement of the hysteresis disc (7). Openings (16) corresponding to the connecting elements (10) are arranged on the hysteresis disc (7), which openings can be brought into engagement in a positive manner with the connecting elements (10). According to the invention, the connecting elements are designed as snap-on elements (10).

The present invention relates to a twisting flyer according to the preamble of claim 1.

A twisting spindle is known from the published application DE 2 134 246, in which a coaxially and rotatably mounted twisting flyer is provided. The twisting flyer is decelerated by a magnetic brake which is arranged on the twisting spindle and which consists of a ferromagnetic disc and a permanent magnet arranged spaced apart therefrom. The permanent magnet is embedded in an adjusting spindle consisting of plastics material, which is rotatably arranged in the twisting flyer bush. The ferromagnetic disc is pressed into a hollowed-out area at the upper end of the spindle shaft and is in operative connection with the permanent magnet.

A hysteresis brake is known from DE 20 2004 003 035 U1 and has a housing produced from a plastics material into which a magnetic carrier is cast. The magnetic carrier is used as a return element for the magnetic circuit formed from permanent magnets. The free pole faces of the permanent magnets point to a magnetic disc, which is cast into a carrier plate made of plastics material. The magnetic disc is positively anchored by undercuts and bores, which are correspondingly conically configured, in the plastics material mass of the carrier plate. During the injection moulding of the carrier plate, the conically configured bores of the magnetic disc are filled with plastics material so a positive connection between the two is produced.

It proves to be disadvantageous that the ferromagnetic disc fastened according to the prior art, or magnetic disc, cannot be detached for maintenance purposes without destruction from the spindle shaft or from the carrier plate.

The invention is therefore based on the object of providing a twisting flyer, which is more maintenance friendly.

This object is achieved according to the invention by the characterising features of claim 1.

Advantageous configurations of the invention are the subject of the sub-claims.

It is proposed according to claim 1 that the connecting elements are configured as snap-on elements. This has the advantage that the hysteresis disc can be assembled in a simple manner by joining, wherein, because of the non-positive connection existing between the snap-on elements and the hysteresis disc, the latter is secured against unintentionally falling out of the rotary bush. The snap-on connection used according to the invention is a type of connection which is extremely suitable for the material and is assembly and disassembly friendly, so the assembly and disassembly of the twisting spindle for maintenance purposes is facilitated. The snap-on connection in particular allows detachment of the hysteresis disc from the rotary bush without destruction. The configuration of the snap-on elements as integrated components of the rotary bush simplifies the production thereof and makes it more economical. The integration of the snap-on elements as a component of the rotary bush takes place by means of injection moulding as an economical and suitable production method.

In particular, the snap-on elements may be slotted, have a substantially annular cross-section and be provided with radially outwardly extending projections at the end, which engage behind the hysteresis disc in sections. In this case, radial fixing of the hysteresis disc is brought about by the snap-on elements penetrating through the openings of the hysteresis disc in the axial direction. Moreover, an axial fixing of the hysteresis disc is achieved by means of the projections which engage behind the hysteresis disc in sections and are configured as undercuts of the snap-on elements required for the snap connection. A further advantage consists in that, in contrast to the use of metallic screws, which could be used, for example, for the detachable connection of the hysteresis disc to the rotary bush, the type of connection according to the invention does not exert any influence on the magnetic field.

The projections may advantageously taper in the axial direction. The tapering configuration of the projections arranged on the snap-on elements at the end in the direction of the end of the snap-on elements remote from the rotary bush has the advantage that the snap-on elements in the arrangement of the hysteresis disc on the rotary bush can more easily be guided through the through-bores on the hysteresis disc.

Furthermore, the snap-on elements may be arranged offset with respect to one another in the peripheral direction of the rotary bush at an angle of between 30° and 120°. An arrangement of the snap-on elements offset with respect to one another by 90° may preferably be provided.

In particular, a roller bearing may be arranged on the support sleeve, on the outer ring of which the rotary bush is non-positively arranged by means of a snap-on connection and on the inner ring of which an adjusting bush is non-positively connected to the roller bearing. Furthermore, the adjusting bush may have a cam, which is guided in a rising groove extending on the support sleeve in the peripheral direction. The adjusting bush is used here for the adjustability of a braking torque to be transmitted, the size of which can be adjusted in steps within a defined range. In this case, to secure a latching position, positioning teeth arranged on the support sleeve and a latching cam arranged on the rotary bush may be provided. By bringing the positioning teeth and the latching cam into engagement in a positive manner, the preadjusted braking torque is fixed.

The invention will be described in more detail below with the aid of an embodiment shown in the drawings, in which:

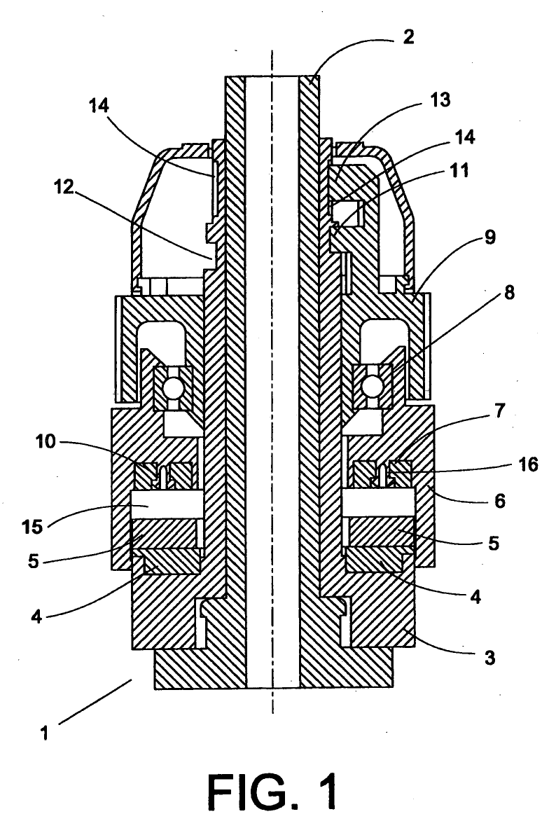

FIG. 1 shows a sectional view of a twisting flyer;

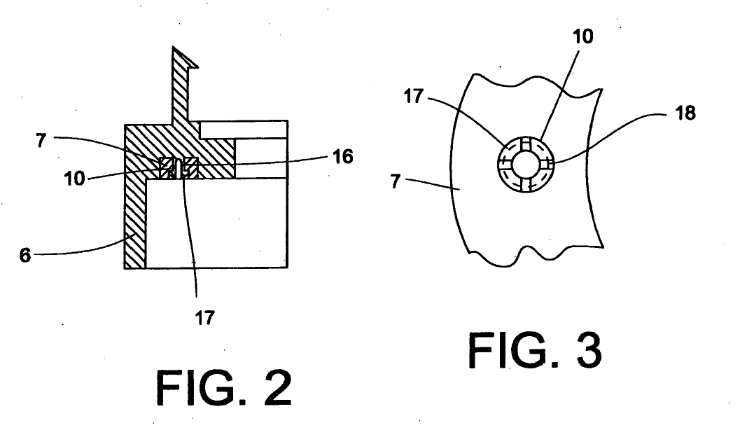

FIG. 2 shows a sectional view of a rotary bush of the twisting flyer according to the invention;

FIG. 3 shows a partial view of a hysteresis disc connected to the rotary bush according to FIG. 2.

FIG. 1 shows a sectional view of a twisting flyer 1, which is arranged on a thread inlet tube 2. The twisting flyer 1 is arranged in a rotation-resistant manner on the thread inlet tube 2. For this purpose, the twisting flyer 1 has a support sleeve 3 which is supported on the base of the thread inlet tube 2. Arranged on the support sleeve 3 are a magnetic return 4 and pole magnets 5 arranged thereon, which are components of a hysteresis brake integrated into the twisting flyer 1. The hysteresis brake is used to generate an adjustable rotation resistance of the bearing of the twisting flyer 1.

The twisting flyer 1 also has a rotary bush 6 and a hysteresis disc 7 arranged in the rotary bush 6. The rotary bush 6 and the hysteresis disc 7 are arranged coaxially with respect to the thread inlet tube 2 on the support sleeve 3. The rotary bush 6 is rotatably mounted on an adjusting bush 9, which is also arranged on the support sleeve 3. For this purpose, a roller bearing 8 is arranged between the adjusting bush 9 and the rotary bush 6, with which roller bearing the rotary bush 6 is non-positively connected by clipping onto the outer ring of the roller bearing 8. The adjusting bush 9 is non-positively connected to the inner ring of the roller bearing 8.

The adjusting bush 9 is guided on the support sleeve 3 by means of a cam 11, which engages in a groove 12 arranged peripherally around the support sleeve 3. This is used for the adjustability of the braking torque to be transmitted. The adjustability of the braking torque is achieved in that an air gap 15 located between the hysteresis disc 7 and the pole magnets 5 is varied with respect to its size by rotating the adjusting bush 9. For this purpose, the groove 12 has a rising course in the peripheral direction of the support sleeve 13, so the pole magnets 5 and the hysteresis disc 7 can be moved toward one another and away from one another. The securing of the latching position is achieved by means of positioning teeth 14 arranged on the support sleeve 3 in conjunction with a latching cam 13 arranged on the rotary bush 6.

In order to achieve a secure fastening of the hysteresis disc 7 on the rotary bush 6, the hysteresis disc 7 is connected to the rotary bush 6 by means of a snap connection. For this purpose, cylindrical, slotted snap-on elements 10 extending coaxially to the longitudinal axis of the thread inlet tube 2, which are used to receive the hysteresis disc 7, as shown in FIG. 2, are arranged on the rotary bush 6.

The snap-on elements 10 are uniformly arranged offset with respect to one another at an angle of 30° to 120°, preferably 90° in the peripheral direction of the rotary bush 6 on the side facing the hysteresis disc 7. The hysteresis disc 7 has through-bores 16 which correspond to the arrangement of the snap-on elements 10 and are used to positively receive the snap-on elements 10 when the hysteresis disc 7 is clipped onto the rotary bush 6.

An additional radial fixing in the clipped-on position of the hysteresis disc 7 is achieved by means of the snap-on elements 10. For axial fixing, the snap-on elements 10 have projections 17 extending outwardly in the radial direction at the end, which engage behind the hysteresis disc 7 in sections in the position attached to the rotary bush 6.

In the case of snap-on connections, it is necessary to overcome an undercut during the joining process. In the present case, these are the projections 17. To attach the hysteresis disc to the rotary bush 6, the slotted snap-on elements 10 each have longitudinal slots 18 arranged offset with respect to one another at an angle of about 90°, which segment the snap-on elements 10. When the hysteresis disc 7 is pressed onto the rotary bush 6, the segmented snap-on elements 10 are pressed together in each case in order to spread apart again on reaching an end position in which the hysteresis disc rests in a planar manner on the rotary bush 6, so that the projections 17 of the snap-on elements 10 engage behind the hysteresis disc 7 in sections.

1. Twisting flyer (1) comprising a rotary bush (6) and a hysteresis disc (7), which are arranged on a support sleeve (3), wherein the hysteresis disc (7) is arranged in the rotary bush (6) coaxially to the longitudinal axis of the support sleeve (3) and the rotary bush (6) has connecting elements (10) for the arrangement of the hysteresis disc (7), and in that openings (16) corresponding to the connecting elements (10) are arranged on the hysteresis disc (7), which openings can be brought into engagement in a positive manner with the connecting elements (10), characterised in that the connecting elements are designed as snap-on elements (10).

2. Twisting flyer (1) according to claim 1, characterised in that the snap-on elements (10) are slotted, have a substantially annular cross-section and have radially outwardly extending projections (17) at the end, which engage behind the hysteresis disc (7) in sections.

3. Twisting flyer (1) according to claim 2, characterised in that the projections (17) taper in the axial direction.

4. Twisting flyer (1) according to claim 1, characterised in that the snap-on elements (10) are arranged offset with respect to one another in the peripheral direction on the rotary bush (6) at an angle of between 30° and 120°.

5. Twisting flyer (1) according to claim 1, characterised in that arranged on the support sleeve (3) is a roller bearing (8), on the outer ring of which the rotary bush (6) is arranged by means of a snap connection and on the inner ring of which an adjusting bush (9) is non-positively connected thereto.

6. Twisting flyer (1) according to claim 5, characterised in that the adjusting bush (9) has a cam (11), which is guided in a rising groove (12) extending in the peripheral direction on the support sleeve (3).

7. Twisting flyer (1) according to claim 5, characterised in that to secure a latching position, positioning teeth (14) arranged on the support sleeve (3) and a latching cam (13) arranged on the rotary bush (6) are provided.
